(19) United States
(12) Patent Application Publication
(10) Pub. No.: US 2023/0204143 A1
(43) Pub. Date: Jun. 29, 2023

(54) PIPE PLUG ARRANGEMENT AND METHOD FOR ACTIVATING SUCH PIPE PLUG ARRANGEMENT

(71) Applicant: NOAQ FLOOD PROTECTION AB, NÄSVIKEN (SE)

(72) Inventor: Sigurd MELIN, NÄSVIKEN (SE)

(21) Appl. No.: 18/008,832

(22) PCT Filed: Jun. 8, 2021
(86) PCT No.: PCT/SE2021/050546

§ 371 Date: Dec. 7, 2022

(30) Foreign Application Priority Data
Jun. 10, 2020 (SE) 2050684-6

(51) Int. Cl. F16L 55/134

(52) U.S. Cl. CPC F16L 55/134

(57) ABSTRACT

Disclosed is a pipe plug arrangement for temporary blocking a duct extending between a first location and a second location, the pipe plug arrangement including a bladder configured to be activated from an inactive state wherein the duct is unblocked to an active state wherein the bladder is filled and the duct is blocked. The pipe plug arrangement is characterized in that the pipe plug arrangement further includes a filler device that is connected to the bladder and has an opening, the opening during the activation of the bladder being arranged at an elevated height in relation to the bladder and being configured to receive liquid, wherein the filler device is configured to fill the bladder with liquid by gravity. Also disclosed is a method for activating such a pipe plug arrangement.

### TECHNICAL FIELD OF THE INVENTION

The present invention relates generally to the field of temporary liquid-damming using a mobile device/arrangement, wherein the device/arrangement is reusable and is brought to different locations suffering from temporary flooding. The present invention relates specifically to the field of mobile plugs which are used for temporary blocking a pipe/culvert/duct extending between a first location (flooded side) to a second location (protected side), and to methods for applying such plugs. There are also other reasons than flooding that requires temporary blocking of a duct, such as during repair or maintenance or preventing hazardous discharge from spreading. The pipe plug arrangement for temporary blocking a duct comprises a bladder configured to be activated from an inactive state wherein the duct is unblocked to an active state wherein the bladder is filled and the duct is blocked.

### BACKGROUND OF THE INVENTION

Flooding may occur in very different areas and under very different circumstances. A frequent type of flooding may hit urban areas and houses situated in the vicinity of watercourses, e.g. lakes and rivers, temporarily overflowing their banks due to extreme weather/rain. Water may then flow over the ground surface to the houses and cause various damage thereto, such as filling possible basements with water and/or partial filling of the ground floor. The water may also cause severe disruptions in traffic/train by flooding underpasses and the like. Water damage of this type are very costly to master. In other cases, liquids of other type than water, e.g. oil, fuels, chemicals and the like, may spill over on areas or surfaces as a consequence of a leakage of an unexpected type. This type of leakage may have severe negative effect on the local environment.

Regardless of the type of flooding, or other need for liquid-damming, there is a general desire to try to prevent the liquid from reaching areas that are in a need to be protected. There are several known and conventional types of temporary protective barriers that are configured to stem the liquid from reaching the protected areas, all types having their own advantages and disadvantages.

Such protective barriers are preferably erected on roads and the like surfaces. However, there are many types of pipes and culverts, for instance for draining away surface water and stormwater and for leading the water past/under roads and railways. There are pipes/culverts/ducts in all sizes, from small pipes for evacuation of excess water from single buildings, to large diameter culverts leading watercourses under roads/railways. However, in a flood situation, these may instead lead water in the wrong direction, i.e. instead of leading water away from buildings to natural recipients in the form of rivers or lakes the water can be led towards buildings and the protected side and cause damage. In such situations there is a need for blocking the flow of water also in the pipe/culvert/duct.

There are known products available that are configured to block the flow of liquid through pipes/culverts. Some of the known plugs are activated by being manually manipulated/operated using tools, for instance the plug has a diameter that is slightly smaller than the inner diameter of the pipe and by means of a screw arrangement a rubber gasket is compressed in the axial direction forcing it to expand radially until the entire area of the pipe is blocked. Such plugs are obviously intended for a certain pipe diameter. Another kind of plug consists of an expandable bladder/balloon that is inserted into the pipe and filled with compressed air from a compressor or a compressed air tank, until the entire area of the pipe is blocked. Such pneumatic plugs require the user to have access to, or being able to produce, compressed air on site, which most users do not have.

### OBJECT OF THE INVENTION

The present invention aims at obviating the above-mentioned disadvantages and failings of previously known pipe plug arrangements and at providing an improved pipe plug arrangement and a method for activating such a pipe plug arrangement.

A primary object of the present invention is to provide an improved pipe plug arrangement of the initially defined type, wherein the activation of the pipe plug arrangement, i.e. activation of the bladder of the pipe plug arrangement, is not dependent on any manual manipulation/activation of the pipe plug using tools or any pressurized fluid provided to the pipe plug arrangement. Thus, no tools or machines are needed to activate the inventive pipe plug arrangement. It is another object of the present invention to provide a pipe plug arrangement that is configured to block pipes/ducts of different dimensions, i.e. different cross-sectional area. It is another object of the present invention to provide a pipe plug arrangement that is simple and cheap.

### SUMMARY OF THE INVENTION

According to the invention at least the primary object is attained by means of the initially defined pipe plug arrangement and method having the features defined in the independent claims. Preferred embodiments of the present invention are further defined in the dependent claims.

According to the present invention, there is provided a pipe plug arrangement that further comprises a filler device that is connected to the bladder and has an opening, the opening during the activation of the bladder being arranged at an elevated height in relation to the bladder and being configured to receive liquid, wherein the filler device is configured to fill the bladder with liquid by means of gravity. The inventive method for activating the bladder of the pipe plug arrangement from an inactive state to an active state comprises the steps of:
installing the inactive bladder into the duct,
connecting the filler device to the bladder,
placing the opening of the filler device at an elevated height in relation to the bladder, and
activating the bladder from the inactive state to the active state by supplying liquid to the opening, the liquid filling the bladder by being guided by the filler device to the bladder by means of gravity.

Thus, the present invention is based on the insight that instead of manual/mechanical activation/manipulation of the bladder using tools or activation of the pipe plug arrangement using pressurized fluid or tools, the water from the flooded side may be used to fill the bladder in order to block the duct/pipe and the difference in height between the bladder and the opening of the filler device is used to fill the bladder and block the duct/pipe by means of gravity. The water used must not originate from the flooded side but may be brought to the location of the filler device in other ways, such as in prefilled vessels.

According to various embodiments the filler device of the pipe plug arrangement comprises a tub having said opening and a conduit extending between said tub and the bladder, wherein the method comprises the step of activating the bladder from the inactive state to the active state by supplying liquid to the opening of the tub, the liquid filling the bladder by being guided by the conduit from the tub to the bladder by means of gravity. Thereby it is easier to supply water/liquid to the filler device, and the tub may be positioned on and may rest on any appropriate surface.

According to various embodiments the conduit is releasably connected to the bladder and/or the tub. Thereby the bladder is more easily emptied after usage and possibly damaged members of the pipe plug arrangement may be exchanged.

According to various embodiments the pipe plug arrangement comprises at least one vessel for supplying liquid/water to the opening of the filler device. The vessel may for instance be constituted by one or more buckets or water cans.

Further advantages with and features of the invention will be apparent from the other dependent claims as well as from the following detailed description of preferred embodiments.

### BRIEF DESCRIPTION OF THE DRAWINGS

A more complete understanding of the abovementioned and other features and advantages of the present invention will be apparent from the following detailed description of preferred embodiments in conjunction with the appended drawings, wherein:

FIG. 1 is a side view of schematic installation of one embodiment of the inventive pipe plug arrangement in a pipe extending under a road separating a flooded side (right) from a protected side (left),

FIG. 2 is a side view of schematic installation of another embodiment of the inventive pipe plug arrangement in a pipe extending under a road separating a flooded side (right) from a protected side (left),

FIG. 3 is a schematic perspective view of a bladder,

FIG. 4 is a schematic end view of a pipe/culvert, wherein the bladder is installed in the pipe according to a first embodiment and is in the inactive state,

FIG. 5 is a schematic view of the installation according to FIG. 4, wherein the bladder is in the active state,

FIG. 6 is a schematic end view of a pipe/culvert, wherein the bladder is installed in the pipe according to a second embodiment and is in the inactive state,

FIG. 7 is a schematic view of the installation according to FIG. 6, wherein the bladder is in the active state,

FIG. 8 is a schematic cross-sectional view of a pipe/culvert, wherein the bladder is installed in the pipe according to a third embodiment and is in the inactive state,

FIG. 9 is a schematic cross-sectional view of the installation according to FIG. 8, wherein the bladder is in the active stat, and

FIG. 10 is a side view of a schematic installation of another embodiment of the inventive pipe plug arrangement in a pipe.

### DETAILED DESCRIPTION OF PREFERRED EMBODIMENTS OF THE INVENTION

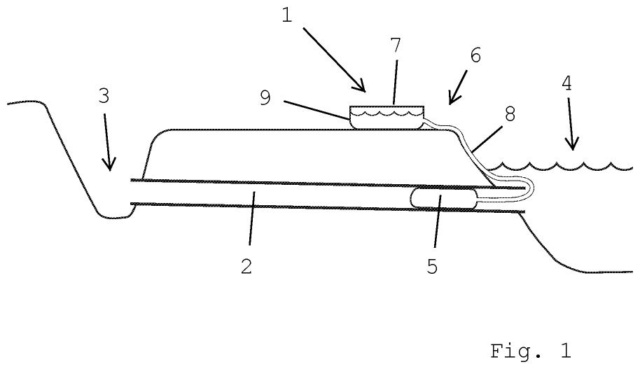

Reference is initially made to the schematic FIG. 1. The present invention relates in general to a mobile and temporary liquid-damming device/arrangement, especially a pipe plug arrangement generally designated 1. The pipe plug arrangement 1 is intended to be used for temporary blocking a duct 2, such as a pipe, culvert, etc., extending between a first location 3 and a second location 4. The first location 3 to the left, also known as protected/dry side, and the second location 4 to the right, also known as flooded/wet side, are separated from each other by natural/permanent and/or mobile/temporary liquid-damming arrangements. A natural/permanent liquid-damming arrangement may be a road as disclosed in FIG. 1.

According to the invention the pipe plug arrangement 1 comprises a bladder 5 and a filler device, generally designated 6. The bladder 5 is configured to be installed into the duct 2 when the bladder 5 is in an inactive state, i.e. the bladder 5 has a smaller cross-sectional area than the duct 2 and the duct 2 is unblocked by the bladder 5. The filler device 6 is connected to the bladder 5 and is configured to fill the bladder 5 with liquid during activation of the bladder 5 from the inactive state to an active state wherein the duct 2 is blocked by the bladder 5. The filler device 6 may be fixedly connected to the bladder 5 or may be releasably connected to the bladder 5. According to the various embodiments the filler device 6 is releasably connected to the bladder 5, the filler device 6 may be connected to the bladder 5 before or after the bladder 5 is installed/placed/inserted into the duct 2.

The filler device 6 has an opening 7 that during activation of the bladder 5 is configured to be arranged at an elevated height in relation to the bladder 5 such that the bladder 5 is filled with liquid by means of gravity. Preferably the opening 7 of the filler device 6 is configured to be located at an elevated height equal to or more than 1 meter in relation to the bladder 5, most preferably equal to or more than 2 meters. The greater the difference in height between the opening 7 of the filler device 6 and the bladder 5 the greater pressure will act inside the bladder 5 when the bladder 5 is in the active state, and the frictional force between the bladder 5 and the pipe 2 will increase. However, the difference in height must not exceed 6 meters, otherwise the stress on the pipe plug arrangement 1 from the internal pressure will be too big.

According to various embodiments the filler device 6 of the pipe plug arrangement 1 comprises a conduit 8 and a tub 9, wherein the conduit 8 extends between the tub 9 and the bladder 5 and the tub 9 comprises said opening 7 that is configured to receive liquid. The conduit 8 may be constituted by one or more flexible hoses extending between the tub 9 and the bladder 5. Each conduit 8 preferably has an inner diameter that is equal to or more than 15 millimetres, preferably equal to or more than 25 millimetres. The conduit 8 preferably has a length that is equal to or more than 3 meters, preferably equal to or more than 5 meters. The length of the conduit 8 is preferably equal to or less than 10 meters, preferably equal to or less than 8 meters. The bladder 5 and the filler device 6 are configured to withstand an internal pressure equal to or more than 3 Bar, preferably equal to or more than 5 Bar. The tub 9 is also known as trough, hopper, reservoir, tank, etc.

The conduit 8 is preferably connected to the tub 9 at the lower half of the tub 9, preferably at the bottom of the tub 9 or adjacent the bottom of the tub 9. The conduit 8 may be fixedly or releasably connected to the tub 9 and to the bladder 5. In the various embodiments the conduit 8 is configured to be releasably connected, the conduit 8 preferably comprises a quick-connection that is configured to be manipulated by hand. The filler device 6 preferably comprises a sieve or screen such that leaves, debris, twig, etc. does not enter the bladder 5 together with the liquid. According to various embodiments the screen may be arranged at the opening 7 or at the connection between the tub 9 and the conduit 8.

When the bladder 5 is installed into the duct 2, the filler device 6 is connected and the opening 7 is located at an elevated height in relation to the bladder 5, liquid such as water from the flooded side is supplied to the opening 7 wherein the liquid is guided by the filler device 6 to the bladder 5 by means of gravity and the bladder 5 is activated from the inactive (empty) state to the active (liquid-filled) state. When the bladder 5 is activated the friction between the bladder 5 and the duct 2 together with the weight of the bladder 5 will prevent the bladder 5 from being displaced along the duct 2 by the water on the flooded side 4. It shall be pointed out that the filler device 6 may alternatively be connected to the bladder 5 before the bladder 5 is inserted into the duct 2.

According to the various embodiments wherein the filler device 6 comprises a tub 9, the liquid is supplied to the tub 9 as long as the liquid level in the tub 9 decreases. When the bladder 5 is filled and the duct 2 is blocked, the filler device 6 may be partly or fully disconnected at the same time as the liquid in the bladder 5 is prevented from being discharged from the bladder 5. For instance the filler device 6 may be disconnected from the bladder 5 and the connection in the bladder 5 is plugged/closed, or the upper end of the conduit 8 is disconnected from the tub 9 and plugged/closed, in order to keep the liquid and the pressure inside the bladder 5. The bladder 5 and/or the filler device 6 may comprise a non-return valve in order to prevent backflow, i.e. in order to keep the liquid and the pressure inside the bladder 5.

According to various embodiments the filler device 6 is only constituted by a conduit 8, and the liquid is supplied to the opening 7 of the conduit 8. The opening 7 of the conduit 8 may be bigger than the normal diameter of the conduit 8.

According to various embodiments, the pipe plug arrangement 1 comprises one or more vessels, such as buckets, water cans, etc. Buckets are preferred when the water/liquid is retrieved from the flooded side 4, and water cans are preferred when the water/liquid is brought to site from another location, i.e. when the bladder 5 is activated before the water starts to rise on the flooded side 4. According to alternative embodiments, especially large diameter ducts 2 wherein one or several cubic meters of water/liquid is needed to fill the bladder 5, the water/liquid used to fill the bladder 5 may be provided from a water tank of a truck, or via a hose connected to the water mains, to a water tap of a house, or the like.

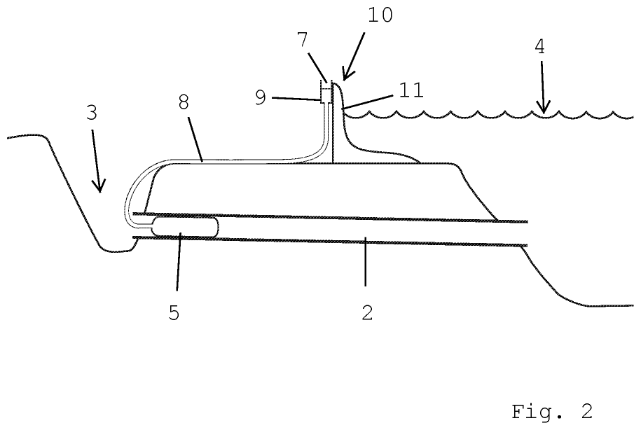

Reference is now also made to FIG. 2 also disclosing a protective barrier 10 that is erected and placed on the road, i.e. abutting directly against the soil/ground or against a similar man-made surface with the purpose of damming liquid. FIG. 2 disclose a cross section of a schematic protective barrier 10, and irrespective the actual design of the cross section of the protective barrier 10 they all have in common that they separate the flooded/wet side 4, to the right of the protective barrier 10, from a protected/dry side 3, to the left of the protective barrier 10. The protective barrier 10 comprises an upright liquid-damming member 11 configured to stem liquid on the flooded side 4 and to prevent the liquid from reaching the protected side 3. The liquid-damming member 11 can be hard, flexible/soft, or combination thereof, and can be self-supporting or supported by other components. The tub 9, i.e. the opening 7 of the filler device 6, may be attached to/arranged at the upper area of the upright member 11 of the protective barrier 10 in order to obtain a greater pressure inside the bladder 5 than the pressure generated by the water on the flooded side of the bladder 5. According to various embodiments the tub 9 may be located on a pile of pallets or at the top of a stepladder or the like, in order to increase the difference in height between the opening 7 and the bladder 5 and thereby the pressure inside the bladder 5. The tub 9 may also be hung from a tree branch or a fence or be placed on the loading platform of a truck. In various embodiments such as the embodiment illustrated in FIG. 2, the tub 9 may be constituted by a jug, pitcher, funnel, etc. hung over the upper edge of the protective barrier 10, wherein the conduit 8 is connected to the bottom thereof, or close to the bottom thereof.

When the pipe plug arrangement 1 is no longer needed the liquid/water is emptied from the bladder 5 and the filler device 6, and the bladder 5 is removed from the duct 2.

Reference is now made to FIG. 3, disclosing a bladder 5 during production.

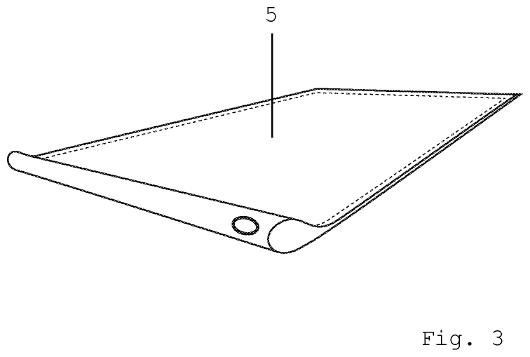

The bladder 5 is preferably constituted by two sheets/layers of liquid impermeable material, such as plastic and/or rubber, wherein the two sheets are connected to each other at the periphery thereof. The material of the bladder 5 may be elastic or non-elastic. The sheets are for instance glued and/or welded to each other along one or more of the edges of the bladder 5. At the edges of the bladder 5, one of the sheets may be folded over the rim of the other sheet and connected. According to one embodiment, disclosed in FIG. 3, along one of the edges of the bladder 5 the two sheets may be connected to each other by folding a larger sheet of material in half, wherein one of the edges is already closed. According to another embodiment, the bladder is made of a cylindrical, tube-shaped, piece of material wherein the two end edges of the tube are closed by being glued and/or welded and the other two edges are already closed. According to another embodiment, the two sheets of material may be indirectly connected to each other along one or more of the edges of the bladder 5 by means of a strip of material running along the periphery of the bladder 5. The filler device 6 is connected to the bladder 5 at or adjacent the periphery of the bladder 5. According to various embodiments the bladder 5, when empty and located outside any duct 2 and unfolded, has a square shape. The axial length of the bladder 5, i.e. along the duct 2, is preferably equal to or more than the diameter of the duct 2 and equal to or less than three times the diameter of the duct 2. The width of the bladder 5, i.e. perpendicular to the axial length, is preferably equal to or more than 1, 6 times the diameter of the duct and equal to or less than 6, 4 times the diameter of the duct 2. The filler device 6 is preferably connected to the bladder 5 at one of the axial edges of the bladder 5. According to the embodiment disclosed in FIGS. 3 and 4 the connection between the bladder 5 and the filler device 6 is preferably close to one of the longitudinal edges of the bladder 5, and according to the embodiments disclosed in FIGS. 5-8 the connection between the bladder 5 and the filler device 6 is preferably close to the middle of the axial edge of the bladder 5. A specific bladder 5 is configured to be used for ducts 2 having a diameter ranging from X to 4 times X centimetres. For instance a small bladder 5 is intended for ducts 2 having a diameter in the range 5-20 centimetres, a medium bladder 5 is intended for ducts 2 having a diameter in the range 15-60 centimetres and a large bladder 5 is intended for ducts 2 having a diameter in the range 50-200 centimetres. Thus, in accordance with the preferred dimensions stated above, the small bladder 5 has a width that is equal to or more than 20 centimetres times 1,6, i.e. 32 centimetres, the medium bladder 5 has a width that is equal to or more than 60 centimetres times 1,6, i.e. 96 centimetres, and the large bladder 5 has a width that is equal to or more than 200 centimetres times 1,6, i.e. 320 centimetres. These dimensions are especially relevant when the bladder is made of a more or less non-elastic material. A bladder made of elastic material may have a smaller width than the above mentioned, depending on the degree of elasticity of the liquid impermeable material of the bladder 5.

Reference is now made to FIGS. 4-9, disclosing a first, a second and a third way to install the bladder 5. Reference is now made to the first embodiment disclosed in FIGS. 4 and 5. Before installation the bladder 5 is rolled to a cylindric form, having the connection between the bladder 5 and the filler device 6 at the outer or inner part of the roll. When the bladder 5 is activated, by means of filling of water, the bladder 5 will partly or fully unfold by the pressure of water until the bladder 5 blocks the entire cross-sectional area of the duct 2. The cylindric form of the rolled together bladder 5 can be maintained with the help of some rubber bands or the like threaded over it in order to facilitate the insertion/installation of the bladder 5 in the duct 2, and the elasticity of these rubber bands allows the bladder to expand when the bladder 5 is activated/filled.

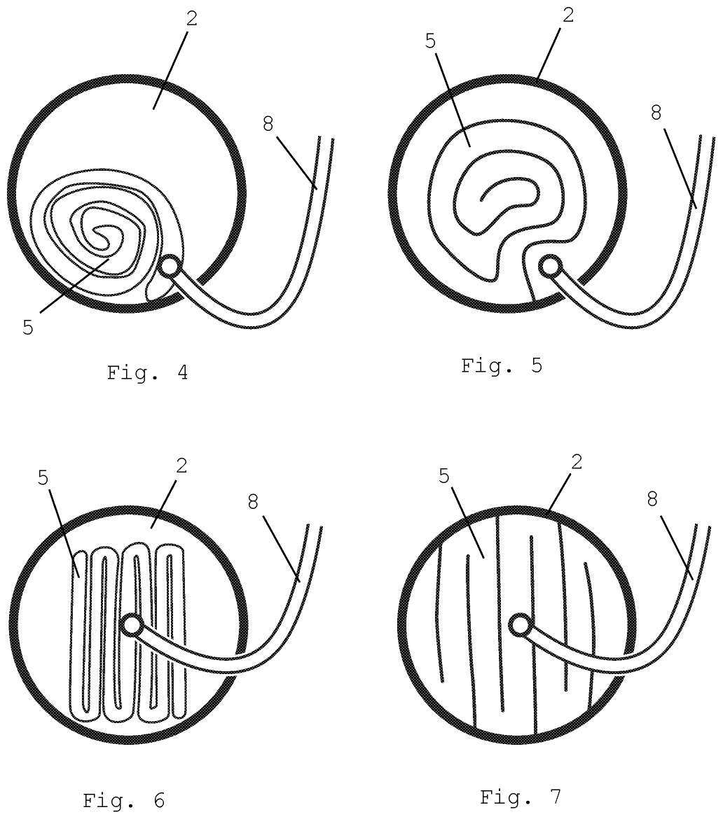

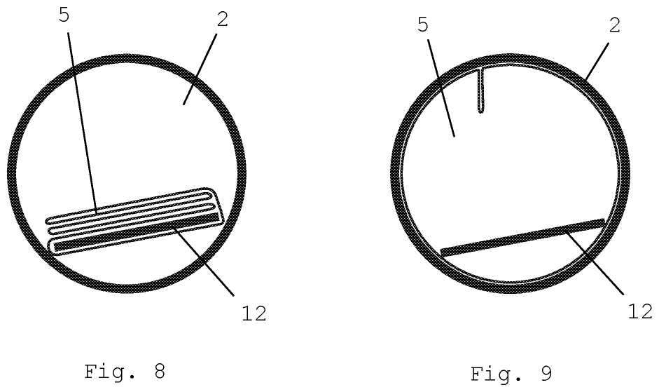

Reference is now made to the second embodiment disclosed in FIGS. 6 and 7. Before installation the bladder 5 is folded to a serpentine/meander form. When the bladder 5 is activated, by means of filling of water, the bladder 5 will partly or fully unfold by the pressure of water until the bladder 5 blocks the entire cross-sectional area of the duct 2. The form of the folded together bladder 5 can be maintained with the help of some rubber bands or the like threaded over it in order to facilitate the insertion/installation of the bladder 5 in the duct 2, and the elasticity of these rubber bands allows the bladder to expand when the bladder 5 is activated/filled.

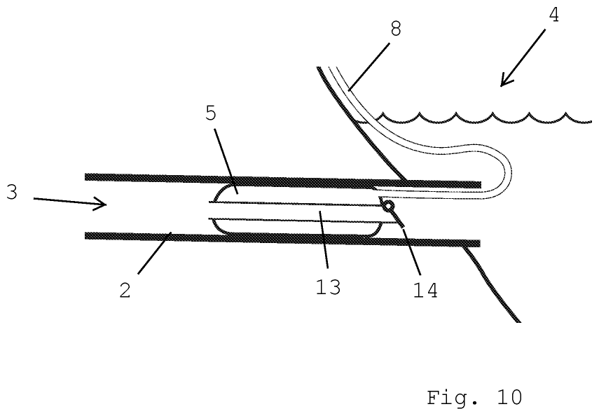

Reference is now made to the third embodiment disclosed in FIGS. 8 and 9. The bladder 5 is provided with an internal structure/frame 12, such as a plate/disc, and before installation the loose part of the sheet of material of the bladder 5 is folded or collected onto the structure/frame 12. When the bladder 5 is activated, by means of filling of water, the bladder 5 will partly or fully unfold by the pressure of water until the bladder 5 blocks the entire cross-sectional area of the duct 2. The form of the collected/folded bladder 5 can be maintained with the help of some rubber bands or the like threaded over it in order to facilitate the insertion/installation of the bladder 5 in the duct 2, and the elasticity of these rubber bands allows the bladder to expand when the bladder 5 is activated/filled.

In all embodiments, the means for holding the inactive bladder 5 in a shape that is easy to install may be configured to break and/or expand when the bladder 5 is filled/activated.

According to various embodiments the bladder 5, especially when the bladder 5 is made of elastic material, may be inserted as a flat or semi-flat form at the bottom of the duct 2. When the bladder 5 is activated/filled, the bladder 5 will expand until the duct 2 is blocked. According to an alternative embodiment, the bladder 5 may be given a cylindrical basic shape, for instance by means of an internal structure/frame. The internal structure/frame may for instance be constituted by a closed container filled with compressed air/gas and located within the bladder 5, entailing that less liquid for filling the bladder 5 is needed due to the closed inner container, or the internal structure/frame may be constituted by a framework. Such internal structures/frames facilitate installation/insertion of the bladder 5 in the duct 2.

Any air/gas trapped in the bladder 5 may be vented via the filler device 6 by having the connection between the bladder 5 and the filler device 6 located at the highest point of the bladder 5.

According to various embodiments, the tub 9 is constituted by a mortar tub of suitable size such as 30-60 liters, but may also have other shape/design. For instance the tub 9 is given the shape of a cylindric pipe/tube of less diameter, for instance a diameter of 15-20 centimeters, such as a sewer pipe closed at the bottom by an ordinary sewer pipe cap. Such pipe is placed upright and can be filled to a significantly higher level than the surface available for placing the tub 9, and thereby the pressure in the bladder 5 is increased.

It shall also be noted that the tub 9 that is filled with water/liquid when activating the bladder 5 may also be used for containing the other members of the pipe plug arrangement 1 for storage and transportation. The volume of the tub 9 is preferably less than 75 liters.

It shall also be pointed out that one filler device 6 may be used for connecting several bladders 5 and/or one bladder 5 may be connected to several filler devices 6.

It shall also be pointed out that the bladder 5 may be installed from the protected side 3 or the flooded side 4 into the duct 2.

Reference is now made to FIG. 10 disclosing an alternative embodiment of the pipe plug arrangement 1, more precisely an alternative embodiment of the bladder 5 that may be used together will all types of filler devices 6. The bladder 5 comprises a through pipe 13, i.e. when the bladder 5 is installed in the duct 2 the through pipe 13 extends between the flooded side 4 and the protected side 3.

The through pipe 13 extends preferably between the two end/axial edges and parallel to the side/longitudinal edges, and may be arranged close to one of the side edges of the bladder 5, or be arranged distances from the side edges. Preferably the material of the bladder 5 is glued and/or welded to the through pipe 13. Alternatively hose clamps may be used to seal between the through pipe 13 and the layers of impermeable material of the bladder 5. According to an alternative embodiment the through pipe 13 is arranged on the outside of the bladder 5, either loose or connected to the bladder 5. The through pipe 13 may for instance be placed on the inner layer of the bladder 5 when rolling the bladder 5 in accordance with FIGS. 4 and 5, or may for instance be placed between two folds of the bladder 5 in accordance with FIGS. 6 and 7 or 8 and 9, or the like. Thus, when the bladder 5 is filled with water the bladder 5 will be pressed against the outside of the through pipe 13 and against the inside of the duct 2.

The through pipe 13 also comprises a non-return valve 14, preferably located at the end of the through pipe 13. The non-return valve 14 is configured to admit flow of water/liquid from the wet side 3 to the flooded side 4. The non-return valve 14 is for instance a hinged lid that is pressed against the end of the through pipe 13 when there is water on the flooded side 4 and thereby prevent the water on the flooded side 4 to reach the protected side 3.

The object of the through pipe 13 is to prevent accumulation of water/liquid on the protected side 3 when the water level at the flooded side 4 is lower than duct 2, or at least lower than the water level on the protected side 3. Usually/preferably the bladder 5 is installed before the water on the flooded side 4 has started to rise over the duct 2. Water in the form of rain or normal surface water will then accumulate on the protected side 3 even though the water level on the flooded side 4 is low. However, thanks to the through pipe 13 and the non-return valve 14 the water arriving to the bladder 5 from the protected side 3 will reach the flooded side 4 as long as the water level on the flooded side 4 is lower than the water level on the protected side 3. Thereto, at the end of a flood period when the water level on the flooded side 4 has started to sink, the water on the protected side 3 is allowed to reach the flooded side 4 already before the bladder 5 is removed from the duct 2.

The through pipe 13 may also comprise a sieve or screen such that leaves, debris, twig, etc. does not enter the through pipe 13 and risk to prevent the non-return valve 14 to close. The sieve/screen is preferably located at the opposite end of the through pipe 13 in relation to the non-return valve 14, i.e. adjacent the protected side 3.

### FEASIBLE MODIFICATIONS OF THE INVENTION

The invention is not limited only to the embodiments described above and shown in the drawings, which primarily have an illustrative and exemplifying purpose. This patent application is intended to cover all adjustments and variants of the preferred embodiments described herein, thus the present invention is defined by the wording of the appended claims and the equivalents thereof. Thus, the equipment may be modified in all kinds of ways within the scope of the appended claims.

It shall also be pointed out that all information about/concerning terms such as above, under, upper, lower, etc., shall be interpreted/read having the equipment oriented according to the figures, having the drawings oriented such that the references can be properly read. Thus, such terms only indicates mutual relations in the shown embodiments, which relations may be changed if the inventive equipment is provided with another structure/design.

It shall be pointed out that in the present application, the diameter of the duct does not necessitate that the duct is cylindrical. The diameter of the duct, as used herein, is equal to the largest distance across the duct whatever shape of the cross-section of the duct.

It shall also be pointed out that even thus it is not explicitly stated that features from a specific embodiment may be combined with features from another embodiment, the combination shall be considered obvious, if the combination is possible.

Throughout this specification and the claims which follows, unless the context requires otherwise, the word “comprise”, and variations such as “comprises” or “comprising”, will be understood to imply the inclusion of a stated integer or steps or group of integers or steps but not the exclusion of any other integer or step or group of integers or steps.

1. A method for activating a bladder of a pipe plug arrangement from an inactive state to an active state for temporary blocking a duct extending from a first location to a second location, wherein the pipe plug arrangement comprises a filler device having an opening configured to receive liquid, the method comprising the steps of:
installing the inactive bladder into the duct,
connecting the filler device to the bladder,
placing the opening of the filler device at an elevated height in relation to the bladder, and
activating the bladder from the inactive state to the active state by supplying liquid to the opening, the liquid filling the bladder by being guided by the filler device to the bladder by means of gravity.

2. The method according to claim 1, wherein the filler device comprises a tub having said opening and a conduit extending between said tub and the bladder, wherein the method comprises the step of:
activating the bladder from the inactive state to the active state by supplying liquid to the opening of the tub, the liquid filling the bladder by being guided by the conduit from the tub to the bladder by means of gravity.

3. The method according to claim 1, wherein the bladder is constituted by two sheets of material connected to each other at the periphery thereof, wherein the method before installation of the bladder into the duct comprises the step of rolling the bladder into a cylindrical shape, or comprises the step of folding the bladder into a meander shape.

4. A pipe plug arrangement for temporary blocking a duct extending between a first location and a second location, the pipe plug arrangement comprising a bladder configured to be activated from an inactive state wherein the duct is unblocked to an active state wherein the bladder is filled and the duct is blocked, wherein the pipe plug arrangement further comprises a filler device that is connected to the bladder and has an opening, the opening during the activation of the bladder being arranged at an elevated height in relation to the bladder and being configured to receive liquid, wherein the filler device is configured to fill the bladder with liquid by means of gravity.

5. The pipe plug arrangement according to claim 4, wherein the filler device comprises a conduit and a tub, the conduit extending between the tub and the bladder, and the tub comprising said opening that is configured to receive liquid.

6. The pipe plug arrangement according to claim 5, wherein the conduit is releasably connected to the bladder and/or the tub.

7. The pipe plug arrangement according to claim 4, wherein the opening of the filler device is configured to be located at an elevated height equal to or more than 1 meter in relation to the bladder.

8. The pipe plug arrangement according to claim 4, wherein the pipe plug arrangement further comprises a vessel for supplying liquid to the opening.

9. The pipe plug arrangement according to claim 4, wherein the bladder comprises two sheets of material connected to each other at the periphery thereof.

10. The pipe plug arrangement according to claim 9, wherein the two sheets of material of the bladder are connected to each other by being glued and/or welded.

11. The pipe plug arrangement according to claim 9, wherein the bladder has a square-shape.

12. The pipe plug arrangement according to claim 9, wherein the two sheets of material of the bladder are provided by folding a single sheet of material in half.

13. The pipe plug arrangement according to claim 4, wherein the bladder comprises a through pipe having a non-return valve, wherein the through pipe is configured to extend between the first location and the second location and the non-return valve is configured to prevent flow of liquid in the direction from the second location towards the first location.

14. The pipe plug arrangement according to claim 5, wherein the opening of the filler device is configured to be located at an elevated height equal to or more than 1 meter in relation to the bladder.

15. The pipe plug arrangement according to claim 6, wherein the opening of the filler device is configured to be located at an elevated height equal to or more than 1 meter in relation to the bladder.

16. The pipe plug arrangement according to claim 5, wherein the pipe plug arrangement further comprises a vessel for supplying liquid to the opening.

17. The pipe plug arrangement according to claim 6, wherein the pipe plug arrangement further comprises a vessel for supplying liquid to the opening.

18. The pipe plug arrangement according to claim 7, wherein the pipe plug arrangement further comprises a vessel for supplying liquid to the opening.

19. The pipe plug arrangement according to claim 5, wherein the bladder comprises two sheets of material connected to each other at the periphery thereof.

20. The pipe plug arrangement according to claim 6, wherein the bladder comprises two sheets of material connected to each other at the periphery thereof.
